(19) United States
(12) Patent Application Publication
(10) Pub. No.: US 2008/0228329 A1
(43) Pub. Date: Sep. 18, 2008

(54) METHODS AND SYSTEMS FOR FRICTION DETECTION AND SLIPPAGE CONTROL

(75) Inventor: Randolph G. Hartman, Plymouth, MN (US)

Correspondence Address: HONEYWELL INTERNATIONAL INC., 101 COLUMBIA ROAD, P O BOX 2245, MORRISTOWN, NJ, 07962-2245, US

(73) Assignee: HONEYWELL INTERNATIONAL INC., Morristown, NJ (US)

(21) Appl. No.: 11/685,507

(22) Filed: Mar. 13, 2007

(51) Int. Cl. G06F 17/00; G05B 13/02

(52) U.S. Cl. 701/1

(57) ABSTRACT

Systems and methods for friction detection and slippage control are provided. In one embodiment, a method for detection and slippage control comprises: measuring vehicle motion, the motion providing data including at least lateral acceleration, longitudinal acceleration and yaw; measuring wheel rotation rates; estimating wheel rotation rates based on the measured vehicle motion, the measured wheel rotation rates, and a vehicle model; estimating a wheel coefficient of friction based the estimated wheel rotation rates, the measured wheel rotation rates, and the vehicle motion; calculating one or both of a road coefficient of friction and a wheel slippage; and producing an output signal representing on one or both of the road coefficient of friction and wheel slippage. When measuring vehicle motion provides less than six-degree-of-freedom measurements, the method further comprises at least one of: detecting driver input; and determining vehicle position from a GNSS signal.

### BACKGROUND

Many vehicles today incorporate Electronic Stability Control (ESC) systems to assists drivers in maintaining or regaining control of their vehicles when driving on slippery surfaces. ESC systems receive inputs that include the rotational angle of the steering column (which indicates the direction the driver desires the vehicle to go) and the yaw rate and lateral acceleration of the vehicle (which indicate the direction the vehicle is actually going). Using these inputs, an ESC controller compares the rotational rate of the vehicle with the steering selection and determines if the driver is over-steering or under-steering the vehicle. Based on this comparison, the ESC controller utilizes the vehicles anti-lock breaking system (ABS) to apply breaking to the vehicle's wheels to restore the vehicle to a nominal position. One problem with ESC systems is that they can only react once over-steering or under-steering is occurring and have no capacity to sense surface conditions to adjust system thresholds, alter vehicle performance, or advise a driver to reduce the likelihood of vehicle slippage from occurring in the first place.

For the reasons stated above and for other reasons stated below which will become apparent to those skilled in the art upon reading and understanding the specification, there is a need in the art for system and methods for friction detection and slippage control using surface condition estimate.

### SUMMARY

The Embodiments of the present invention provide methods and systems for friction detection and slippage control and will be understood by reading and studying the following specification.

In one embodiment, a method for detection and slippage control for a vehicle is provided. The method comprises measuring vehicle motion, the motion providing data including at least lateral acceleration, longitudinal acceleration and yaw; measuring wheel rotation rates; estimating wheel rotation rates based on the measured vehicle motion, the measured wheel rotation rates, and a vehicle model; estimating a wheel coefficient of friction based the estimated wheel rotation rates, the measured wheel rotation rates, and the vehicle motion; calculating one or both of a road coefficient of friction and a wheel slippage; and producing an output signal representing on one or both of the road coefficient of friction and wheel slippage. When measuring vehicle motion provides less than six-degree-of-freedom measurements, the method further comprises at least one of: detecting driver input; and determining vehicle position from a GNSS signal.

### DRAWINGS

Embodiments of the present invention can be more easily understood and further advantages and uses thereof more readily apparent, when considered in view of the description of the preferred embodiments and the following figures in which:

FIG. 1 is a block diagram illustrating a friction detection and slippage control system of one embodiment of the present invention;

FIG. 2 is a block diagram illustrating a friction estimate algorithm of one embodiment of the present invention; and

FIG. 3 is a flow chart illustrating a method for friction detection and slippage control of one embodiment of the present invention.

In accordance with common practice, the various described features are not drawn to scale but are drawn to emphasize features relevant to the present invention. Reference characters denote like elements throughout figures and text.

### DETAILED DESCRIPTION

In the following detailed description, reference is made to the accompanying drawings that form a part hereof, and in which is shown by way of specific illustrative embodiments in which the invention may be practiced. These embodiments are described in sufficient detail to enable those skilled in the art to practice the invention, and it is to be understood that other embodiments may be utilized and that logical, mechanical and electrical changes may be made without departing from the scope of the present invention. The following detailed description is, therefore, not to be taken in a limiting sense.

Embodiments of the present invention provide systems and methods that enable a vehicle to estimate the coefficient of friction between the vehicle and the driving surface and provide a quantified estimate of any slippage occurring. This invention assumes that the road surface over the region of interest is relatively constant, however the information is updated on a regular basis. The frequency of update and any information smoothing would be application dependent. For instance, the update rate would be much higher for a farm tractor in the field where the surfaces changes dramatically over a short interval and speeds are reduced and lower for highway applications where changes in surface would occur over longer intervals and speeds are much higher. Using this information a vehicle can avoid operating in such a manner as to cause slippage, or mitigate the consequences when slippage does occur. For example, when a coefficient of friction estimate provided by one of the embodiments of the present invention indicates that slippage is likely, a vehicle can adapt by reducing vehicle speed, limiting acceleration, limiting turn rated or altering its physical characteristics such as, but not limited to, altering tire pressures, shifting the distribution of the weight of the vehicle and altering the dampening characteristics of shock-absorbers. The vehicle could also provide warnings to the driver when slippage or a low coefficient of friction is detected. The vehicle can alter operating characteristics such as, but not limited to, independently apply breaks differently for each wheel to avoid or control slippage. When a low coefficient of friction is estimated, or when wheel slippage is detected, the vehicle can maximize vehicle acceleration by regulating the acceleration of drive wheels to compensate for slippage. Further, in advanced highway systems where highway structural information is available to the vehicle, the vehicle can warn a driver that it cannot handle an upcoming curve at the current speed and vehicle configuration given the current coefficient of friction estimates.

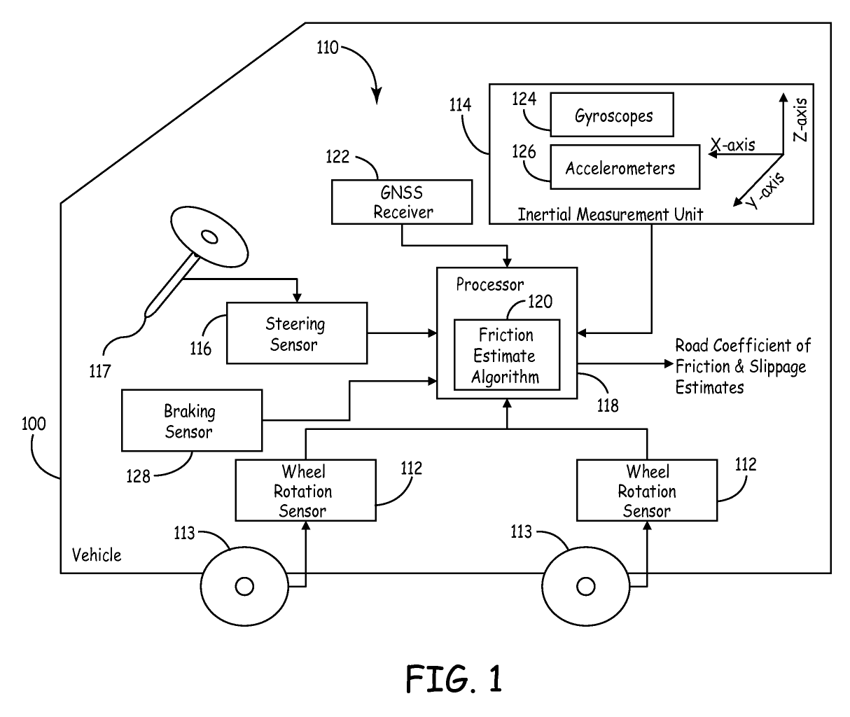

FIG. 1 is a diagram illustrating a friction detection system 110 for a vehicle 100 of one embodiment of the present invention. Examples of vehicle 100 include, but are not limited to, an automobile, an all-terrain vehicle, a truck, a tractor, and farm implements such as mobile harvesting machinery. As shown in FIG. 1, friction detection system 110 comprises wheel rotation sensors 112, an inertial measurement unit 114, a steering sensor 116, a Global Navigation Satellite System (GNSS) receiver 122, a braking sensor 128, and a processor 118.

Wheel rotation sensors 112 measure the rotational rate of each of vehicle 100's wheels (shown at 113). The term “wheels” as used in this application include, but are not limited, to hubs mounted tires and tractor treads. Each sensor of wheel rotation sensors 112 is coupled to processor 118 and provides processor 118 with a signal that represents the rotational rate of the wheel they are measuring. In one embodiment, wheel rotation sensors 112 include a magnetic/inductive sensor that produces an electrical signal representing the rotational rate of a wheel. In other embodiments other rotational sensors are used.

Inertial measurement unit 114 is coupled to processor 118 and provides inertial measurements representing vehicle 100's yaw, pitch and roll to processor 118. As would be appreciated by one of ordinary skill in the art upon reading this specification, yaw, pitch and roll measurements may incorporate yaw, pitch and roll rotational accelerations; yaw, pitch and roll rotational rates; yaw, pitch and roll absolute measurements; or any combination thereof. Inertial measurement unit 114 also produces one or more signals that provides processor 118 with the lateral acceleration (x-axis), longitudinal acceleration (y-axis) and vertical acceleration (z-axis) of vehicle 100. In one embodiment, inertial measurement unit 114 comprises one or more micro-electromechanical systems (MEMS) gyroscopes 124 and accelerometers 126. In other embodiment, other gyroscopes 124 and accelerometers 126 are used.

In the embodiment shown in FIG. 1, a Global Navigation Satellite System (GNSS) receiver 122, such as, but not limited to a Global Positioning System (GPS) receiver determines velocity of vehicle 100 (such as lateral, longitudinal and normal velocity, for example) and provides processor 118 with the vehicle velocity. Friction estimate algorithm 120 incorporates the velocity information as additional measurements for the purpose of estimating “n” wheel rotation/rotation rates.

Steering sensor 116 is coupled to processor 118 and provides steering angle data to processor 118. In one embodiment, the steering data represents directional input provided by the driver of the vehicle. In other words, steering sensor 116 determines what direction the driver is telling the vehicle to go. In one embodiment, steering sensor 116 determines an angle of rotation of the vehicle 100's steering column 117 and produces one or more signals that provides processor 118 with the steering angle of the steering column 117. In one embodiment, steering sensor 116 comprises a magnetic rotation sensor. In other embodiments, where the driver controls vehicle direction by an alternate means other than a steering wheel, steering sensor 116 produces one or more signals that represent directional input provided by the driver via those alternate means, and provides that information to processor 118. One example of an alternate means includes a user interface that allows the driver to enter a numerical input that indicates what direction the driver is directing the vehicle to go.

Braking sensor 128 is coupled to processor 118 and provides vehicle braking information to processor 118. In one embodiment, the braking information represents slowing input provided by the driver of the vehicle. For example, the slowing input can include pressure placed on a breaking control by the driver, or an angle of a breaking control operated by the driver. In other words, braking sensor 128 determines when the driver is attempting to slow the vehicle and the rate of slowing directed by the driver. In one embodiment, breaking sensor 128 comprises a pressure braking sensor. In other embodiments, alternate sensors could be used. Braking sensor 128 may also provide information regarding the effectiveness of vehicle 100's braking systems, such as whether a particular set of breaks is locked.

Processor 118 is programmed to receive the wheel rotation data from wheel rotation sensors 112, the inertial measurement data from inertial measurement unit 114, breaking information from breaking sensor 128, GNSS measurement data from GNSS receiver 122, and the steering angle data from steering sensor 116, and calculate an estimated coefficient of friction based on the wheel rotation data, the inertial measurement data, breaking information, the GNSS measurement data, and the steering angle data. Using this information, processor 118 is programmed to compare measurements of the driver's input (e.g., steering and breaking information) and measurements of the vehicles motion (e.g., GNSS measurement data and inertial measurement data) against the measured rotation of each of vehicle 100's wheels to estimate a coefficient of friction and slippage. In one embodiment, processor 118 implements a friction estimate algorithm 120 that calculates for each wheel an estimated wheel rotation rate based on the inertial measurement data, the steering angle data, and physical characteristics of the vehicle such as the circumference of the wheels, wheelbase and axle length. Other physical characteristics may include, but are not limited to, the weight of the vehicle, the air pressure of a tire, the width of the wheel, tread type and the material used to construct the wheel.

In one embodiment, friction estimate algorithm 120 includes a Kalman filter algorithm. As would be appreciated by one skilled in the art upon studying this specification, a Kalman filter algorithm is a recursive filter which estimates one or more state variables of a dynamic system from a series of incomplete, noisy, or relatively imprecise measurements. Although a Kalman filter is specifically discussed in this specification, one of ordinary skill in the art upon reading this specification would appreciate that embodiments of the present invention are not limited to using Kalman filters but may use other such filters to estimate the one or more state variables.

Given the inputs discussed above, implementing a friction estimate algorithm 120 to calculate of an estimated wheel rotation rate is readily accomplished by one of ordinary skill in the art of automotive dynamics upon studying this specification and is discussed in greater detail below. The difference between the estimated wheel rotation rate and the measured wheel rotation rate is a function of the slippage occurring, which is in turn a function of the coefficient of friction between the wheel and the surface of the road. Therefore, based on the difference between the estimated wheel rotation rate and the measured wheel rotation rate, friction estimate algorithm 120 calculates one or both of an estimated coefficient of friction and an estimated slippage for each of vehicle 100's (n) wheels.

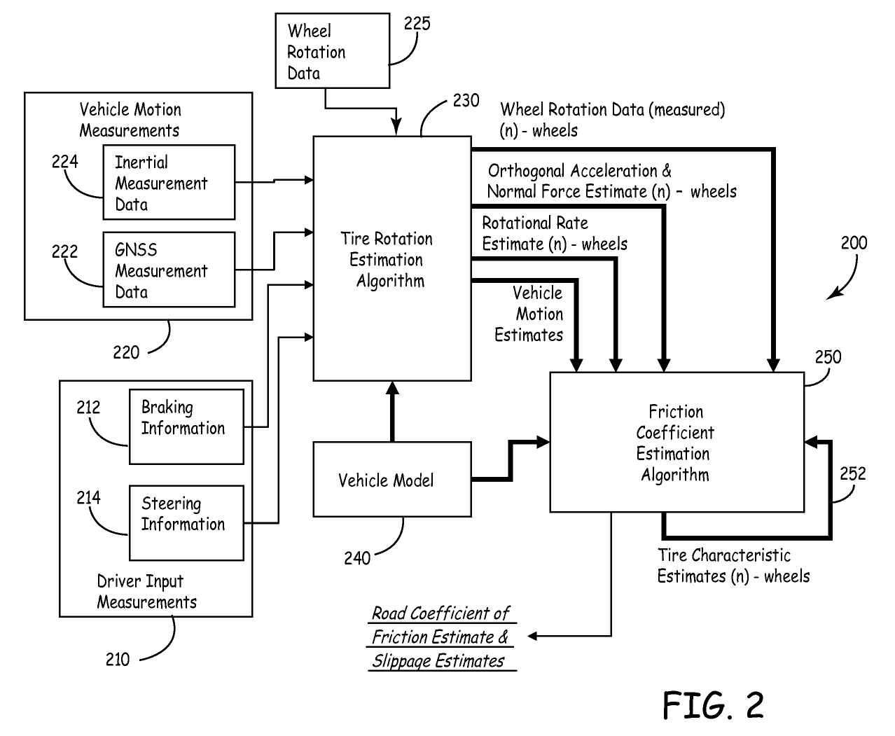

FIG. 2 is a block diagram representation of a friction estimate algorithm 200 of one embodiment of the present invention. As previously mentioned, in order to resolve a coefficient of slippage the difference between an estimated rotation rate and a measured rotation rate is calculated based on driver input measurements, measurements of vehicle motion, and measured wheel rotation rates. Driver input measurements (shown at 210) include steering information (shown at 212) and breaking information (shown at 214), both of which provide information regarding the Driver's intent. Measurements of vehicle motion (shown at 220) include GNSS measurement data (shown at 222) and inertial measurement data (shown at block 224). Wheel rotation data (shown at 225) includes the rotational rate of each of vehicle 100's wheels as measured by wheel rotation sensors 112.

The driver input measurements 210, measurement of vehicles motion 220, and wheel rotation data 225, are provided to tire rotation estimation algorithm 230. Friction estimate algorithm 200 also includes a vehicle model 240 that provides tire rotation estimation algorithm 230 a model for estimating vehicle 100's dynamics based on physical characteristics of the vehicle. Such physical characteristics include, but are not limited to vehicle 100's dimensions and weight. Vehicle model 240 can also include wheel characteristics such as tire circumference, tire width, tread type, sidewall stiffness and tire pressure. For each wheel, tire rotation estimation algorithm 230 calculates an estimated wheel rotation rate, estimations of accelerations and forces acting on the wheel (orthogonal acceleration and normal force estimates, for example) as well estimates regarding vehicle motion including the effect of the driver input measurements 210, vehicles motion measurements 220 and wheel rotation data 225. As shown in FIG. 2, any of these estimates regarding vehicle motion may also be passed to friction coefficient estimation algorithm 250.

Depending on what complement of the various sensors is available, tire rotation estimation algorithm 230 is appropriately configured to perform its calculations. For example, as would be appreciated by one of ordinary skill in the art upon studying this invention, when GNSS measurement data is available to tire rotation estimation algorithm 230, driver input measurements with respect to steering information is an optional input. Similarly, when the inertial measurement data provides 3-axes of gyroscope data and 3-axes of acceleration measurements (commonly referred to as six-degree-of-freedom inertial data), having driver input measurements with respect to steering information is also optional. In both of these cases the availability of steering information will increase the accuracy of tire rotation estimation algorithm 230's calculations, but it is not required when GNSS measurement data or six-degree-of-freedom inertial data is available. In the same way, the availability of breaking information will increase the accuracy of tire rotation estimation algorithm 230's calculations, but is not required.

Friction coefficient estimation algorithm 250 inputs the estimated wheel rotation rates, estimations of accelerations and forces acting on the wheels from tire rotation estimation algorithm 230. In one alternate embodiment where GNSS measurement data 222 is not available, tire rotation estimation algorithm 230 also passes measured wheel rotation data for each of (n) wheels to coefficient estimation algorithm 250. In one such embodiment, coefficient estimation algorithm 250 uses wheel rotation data 225 from wheel rotation sensors 112 that is averaged together.

Incorporating the vehicle characteristics provided by vehicle model 240 with the inputs provided by tire rotation estimation algorithm 230, friction coefficient estimation algorithm 250 implements a Kalman filter that estimates the wheel slippage and a coefficient of friction between each wheel and the surface of the road. From the estimate of the coefficient of friction between each wheel and the surface of the road, friction coefficient estimation algorithm 250 calculates the coefficient of friction for the road itself. In the process of calculating the coefficient of friction for the road and the slippage estimates for each wheel, friction coefficient estimation algorithm 250 also generates tire characteristic estimates (shown at 252). The specific tire characteristics of interest would be effective circumference, side distortion and effective friction term. Effective circumference is the estimate of circumference given the current tire pressure, side distortion is a factor which describes the changes in performance in turns and effective friction helps to define the slippage resistance of this tire. Tire characteristic estimates 252 are fed back into friction coefficient estimation algorithm 250 for subsequent calculation iterations.

As mentioned above, friction estimate algorithm 200 will produce more accurate estimates when tire rotation estimation algorithm 230 has vehicle motion measurements 220 that includes inertial measurement data 224 that includes 3-axes of gyroscope data plus 3-axes of acceleration measurements (i.e., six-degree-of-freedom inertial measurements) in addition to GNSS measurement data 222. Other embodiments providing alternate complements of vehicle motion measurements, however, are also contemplated as within the scope of embodiment of the present invention. For example, in one embodiment, vehicle motion measurements 220 include six-degree-of-freedom inertial measurements without GNSS measurement data. In another embodiment, vehicle motion measurements 220 include inertial measurements comprising data from one gyroscope and two accelerometers (providing lateral acceleration (x-axis), longitudinal acceleration (y-axis) and yaw of vehicle 100, for example) plus GNSS measurement data. Similarly, although FIG. 2 describes tire rotation estimation algorithm 230 as having both steering information 212 and braking information 214, other embodiments utilize only the steering information 212 as the indication of the Driver's intent.

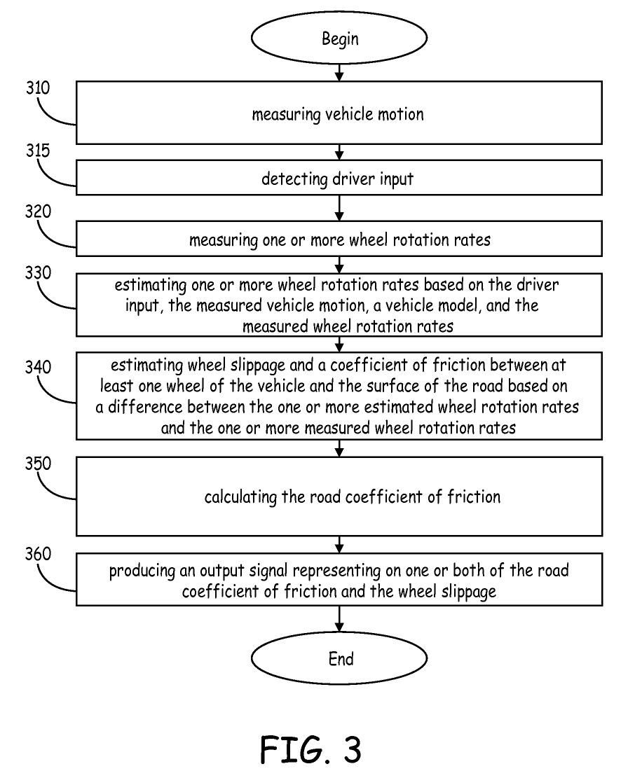

FIG. 3 is a flow chart illustrating a method of one embodiment of the present invention. In one embodiment, the method illustrated in FIG. 2 is implemented using a friction detection system for a vehicle such as described with respect to FIG. 1.

The method begins at 310 with measuring vehicle motion. In one embodiment, measuring vehicle motion includes obtaining both GNSS measurement data and six-degree-of-freedom inertial measurement data. As discussed above, in alternate embodiments, alternate complements of vehicle motion measurements are also contemplated as for measuring vehicle motion. In one embodiment, inertial measurement data is measured using a combination of MEMS gyroscopes and accelerometers. In other embodiment, other gyroscopes and accelerometers are used. In one embodiment, GNSS measurement data is provided by a Global Positioning System (GPS) receiver. As would be appreciated by one of ordinary skill in the art upon reading this specification, there are many methods to estimate the current motion of the vehicle based on inertial, magnetic or telematic means such as but not limited to GNSS, each of which are contemplated as within the scope of embodiments of the present invention.

The method proceeds to 315 with detecting driver input. In one embodiment, driver input includes steering information and breaking information, both of which provide information regarding the Driver's intent regarding the direction and speed of the vehicle. In one embodiment, detecting driver input includes determining an angle of rotation of a steering column based on a steering sensor such as, but not limited to a magnetic rotation sensor. In other embodiments, where the driver controls the vehicle's direction by an alternate means other than a steering wheel, the steering sensor produces signals that represent directional input provided by the driver via those alternate means. In one embodiment, detecting driver input also includes obtaining braking information that represents slowing input provided by the driver of the vehicle. For example, the slowing input can include pressure placed on a breaking control by the driver, or an angle of a breaking control operated by the driver. As discussed above, there are many means available for estimating a driver's intent, including measuring the angle of the wheels, and while driver's intent information is beneficial, it is not required to determine the slippage.

The method proceeds to 320 with measuring one or more wheel rotation rates. As would be appreciated by one of ordinary skill in the art upon reading this specification, obtaining wheel rotation rates from all of the vehicle wheels will produce more a more accurate estimate of road friction than an estimate based on a few number of wheels. However, embodiments where rotation rates from fewer than all of the vehicle wheels are obtained are also contemplated as within the scope of embodiments of the present invention. In one embodiment, measuring wheel rotation rates is accomplished by receiving at least one electrical signal representing the rotational rate of a wheel based on magnetic/inductive sensors. In other embodiments, other rotation sensors are used.

The method proceeds to 330 with estimating one or more wheel rotation rates based on the driver input, the measured vehicle motion, physical characteristics provided by the vehicle model, and previously measured wheel rotation rates. In one embodiment, calculating the estimated wheel rotation rates also produces estimations of accelerations and forces acting on each wheel as well estimates regarding vehicle motion, the accuracy of the driver input measurements, the measurements of vehicles motion, and the measured wheel rotation rates.

The method proceeds to 340 with estimating a wheel slippage and a coefficient of friction between at least one wheel of the vehicle and the surface of the road based on a difference between the one or more estimated wheel rotation rates and the one or more measured wheel rotation rates. In one embodiment, the estimate further incorporates the accuracy estimates for the driver input measurements, the measurements of vehicles motion, and the measured wheel rotation rates (produced at 330) and is further based on vehicle dynamics provided by the vehicle model. In one alternate embodiment where GNSS measurement data is not available, estimating the coefficient of friction at 340 also incorporates measured wheel rotation data from wheel rotation sensors.

In one embodiment, estimating a coefficient of friction for each wheel also produces tire characteristic estimates. The specific tire characteristics of interest would be effective circumference, side distortion and effective friction term. Effective circumference is the estimate of circumference given the current tire pressure, side distortion is a factor which describes the changes in performance in turns and effective friction helps to define the slippage resistance of this tire. In one embodiment, the tire characteristic estimates are stored and used for subsequent estimations.

The difference between the estimated wheel rotation rate and the measured wheel rotation rate, when combined with inertial measurement data, is a function of the slippage occurring, which is in turn a function of the coefficient of friction of the surface of the road. Therefore, the method proceeds to 350 with calculating the road coefficient of friction and the wheel slippage for each wheel of the vehicle.

The method the proceeds to 360 with producing an output signal representing on one or both of the coefficient of friction and the wheel slippage. In one embodiment, producing an output signal enables generating warnings to the driver based on the estimated coefficient of friction and slippage of the vehicle. For example, if the road has become iced, which lowers the coefficient of friction, the vehicle can warn the driver of the condition so that they may take appropriate actions. In other embodiments, producing an output signal includes generating one or more control signals based on the estimated coefficient of friction and slippage of the vehicle. In one embodiment, using the control signals, the vehicle may alter its response to driver inputs based on the estimated coefficient of friction and slippage. For example, in one embodiment where the vehicle is a farm tractor, the vehicle may dampen its response to a driver demand for acceleration when slippery field conditions are detected.

Several means are available to implement the systems and methods of the current invention as discussed in this specification. These means include, but are not limited to, digital computer systems, microprocessors, general purpose computers, programmable controllers and field programmable gate arrays. Therefore other embodiments of the present invention are program instructions resident on computer readable media which when implemented by such controllers, enable the controllers to implement embodiments of the present invention. Computer readable media include any form of computer memory, including but not limited to punch cards, magnetic disk or tape, any optical data storage system, flash read only memory (ROM), non-volatile ROM, programmable ROM (PROM), erasable-programmable ROM (E-PROM), random access memory (RAM), or any other form of permanent, semi-permanent, or temporary memory storage system or device. Program instructions include, but are not limited to computer-executable instructions executed by computer system processors and hardware description languages such as Very High Speed Integrated Circuit (VHSIC) Hardware Description Language (VHDL).

Although specific embodiments have been illustrated and described herein, it will be appreciated by those of ordinary skill in the art that any arrangement, which is calculated to achieve the same purpose, may be substituted for the specific embodiment shown. This application is intended to cover any adaptations or variations of the present invention. Therefore, it is manifestly intended that this invention be limited only by the claims and the equivalents thereof.

What is claimed is:

1. A friction detection system for a vehicle, the system comprising:
a processor;
at least one wheel rotational sensor coupled to the processor and configures to provide the processor with a signal that represents a measured wheel rotational rate;
inertial sensors coupled to the processor and configured to provide the processor with inertial measurement data, the inertial sensors providing at least a lateral acceleration measurement, a longitudinal acceleration measurement and a yaw measurement;
wherein the processor is configured to calculate an estimated coefficient of friction of a road surface based on the inertial measurement data, the measured wheel rotational rate and a model of the vehicle;
wherein when the inertial measurement data does not include a pitch measurement, a roll measurement, and a vertical acceleration measurement, the system further comprises at least one of:
a steering sensor coupled to the processor and configured to provide the processor with a signal that represents a directional input, and
a global navigation satellite system (GNSS) receiver coupled to the processor and configured to provide the processor with position data; and
wherein the processor is further configured to calculate the estimates coefficient of friction of a road surface further based on one or both of the directional input and the position data.

2. The system of claim 1, wherein the processor is further configured to calculate a slippage estimate for at least one wheel of the vehicle.

3. The system of claim 1, further comprising a braking sensor coupled to the processor and configured to provide the processor with braking data.

4. The system of claim 1, further comprising a steering sensor coupled to the processor and configured to provide the processor with a signal that represents a directional input.

5. The system of claim 1, further comprising a global navigation satellite system (GNSS) receiver coupled to the processor and configured to provide the processor with position data.

6. The system of claim 1, wherein the at least one wheel rotation sensor further comprises a magnetic/inductive sensor that produces an electrical signal representing the rotational rate of a wheel.

7. The system of claim 1, wherein the inertial sensors comprise at least one electromechanical gyroscope and two or more electromechanical accelerometers.

8. The system of claim 1, wherein the inertial sensors provide inertial measurements including at least the yaw of the vehicle, the lateral acceleration of the vehicle, and the longitudinal acceleration of the vehicle and at least one of the pitch of the vehicle, the roll of the vehicle, and the vertical acceleration of the vehicle.

9. The system of claim 1, wherein the steering sensor comprises a magnetic YAW rotation sensor.

10. The system of claim 1, wherein the processor is configured to calculate an estimated wheel rotation rate based on at least the inertial measurement data, the measured wheel rotational rate and the model of the vehicle; and
wherein the processor is further configured to calculate the estimated coefficient of friction of a road surface based on a difference between the estimated wheel rotation rate and the measured wheel rotational rate.

11. The system of claim 1, wherein the model of the vehicle is based on one or more physical characteristics of the vehicle.

12. A method for detection and slippage control for a vehicle, the method comprising:
measuring vehicle motion, the vehicle motion providing inertial data including at least a lateral acceleration measurement, a longitudinal acceleration measurement and a yaw measurement;
measuring one or more measured wheel rotation rates;
estimating one or more estimated wheel rotation rates based on the measured vehicle motion, the measured wheel rotation rates, and a vehicle model;
estimating a wheel coefficient of friction between at least one wheel of the vehicle and a road surface based on one or more estimated wheel rotation rates, the one or more measured wheel rotation rates, and the measured vehicle motion;
calculating one or both of a road coefficient of friction and at least one wheel slippage; and
producing an output signal representing on one or both of the road coefficient of friction and the at least one wheel slippage;
wherein when measuring vehicle motion does not provides a pitch measurement, a roll measurement, and a vertical acceleration measurement, the method further comprises at least one of:
detecting driver input; and
determining vehicle position based on a global navigation satellite system (GNSS) signal.

13. The method of claim 12, wherein detecting driver input further comprises one or both of detecting a directional input and detecting braking data.

14. The method of claim 12, further comprising determining vehicle position based on a global navigation satellite system (GNSS) signal.

15. The method of claim 12, further comprising detecting driver input including at least one of braking information and steering information.

16. The method of claim 12, wherein measuring vehicle motion further comprises measuring inertial measurements including at least the yaw of the vehicle, the lateral acceleration of the vehicle, and the longitudinal acceleration of the vehicle and at least one of the pitch of the vehicle, the roll of the vehicle, and the vertical acceleration of the vehicle.

17. A computer-readable medium having computer-executable instructions for a method for detection and slippage control for a vehicle, the method comprising:
receiving inertial measurement data from one or more inertial sensors, the inertial measurement including at least a lateral acceleration measurement, a longitudinal acceleration measurement and a yaw measurement;
receiving one or more measured wheel rotation rates;
calculating at least one estimated wheel rotation rate based on the inertial measurement data, the one or more measured wheel rotation rates and a vehicle model;
calculating a wheel coefficient of friction based on the at least one estimated wheel rotation rate, the one or more measured wheel rotation rates and the inertial measurement data; and
calculating one or both of a road surface coefficient of friction and a wheel slippage, based on the wheel coefficient of friction;
wherein when the inertial measurement data does not provide a pitch measurement, a roll measurement, and a vertical acceleration measurement, the method further comprises at least one of:
receiving directional input information from a steering sensor; and
determining vehicle position based on a global navigation satellite system (GNSS) signal; and
wherein calculating a wheel coefficient of friction is further based on one or both of the directional input and the vehicle position.

18. The computer-readable medium of claim 17, further comprising receiving braking data from one or more braking sensors, wherein calculating at least one estimated wheel rotation rate is further based on the braking data.

19. The computer-readable medium of claim 17, further comprising receiving position data from a global navigation satellite system (GNSS) receiver, wherein calculating at least one estimated wheel rotation rate is further based on the position data.

20. The computer-readable medium of claim 17, wherein receiving inertial measurement data further comprises receiving inertial measurements including at least the yaw of the vehicle, the lateral acceleration of the vehicle, and the longitudinal acceleration of the vehicle and at least one of the pitch of the vehicle, the roll of the vehicle, and the vertical acceleration of the vehicle.
